(19) United States
(12) Patent Application Publication
(10) Pub. No.: US 2014/0243086 A1
(43) Pub. Date: Aug. 28, 2014

(54) SERVER, METHOD FOR CONTROLLING A GAME IN A SERVER, MOBILE APPARATUS, METHOD FOR CONTROLLING A MOBILE APPARATUS, DISPLAY APPARATUS, AND METHOD FOR DISPLAYING A GAME IMAGE IN A DISPLAY APPARATUS

(71) Applicant: SAMSUNG ELECTRONICS CO., LTD., Suwon-si (KR)

(72) Inventors: Seung-joo YANG, Suwon-si (KR); Han KANG, Gwangju (KR); Doh-hyeong LEE, Seoul (KR)

(73) Assignee: SAMSUNG ELECTRONICS CO., LTD., Suwon-si (KR)

(21) Appl. No.: 14/186,126

(22) Filed: Feb. 21, 2014

(30) Foreign Application Priority Data
Feb. 25, 2013 (KR) 10-2013-0020007

(51) Int. Cl. A63F 13/30

(52) U.S. Cl. CPC A63F 13/12
USPC 463/31

(57) ABSTRACT

A method for controlling a game in a server which is connectable to a display apparatus and a mobile apparatus is provided. The game controlling method includes, when a game execution command is received from a mobile apparatus, providing the mobile apparatus with a manipulation content which corresponds to the game execution command, generating a game image which corresponds to the game execution command as a real-time stream, and transmitting the generated real-time stream to the display apparatus.

### CROSS-REFERENCE TO RELATED APPLICATIONS

This application claims priority from Korean Patent Application No. 10-2013-0020007, filed in the Korean Intellectual Property Office on Feb. 25, 2013, the disclosure of which is incorporated herein by reference.

### BACKGROUND OF THE INVENTION

1. Field of the Invention

The present general inventive concept generally relates to a server, a method for controlling a game in a server, a mobile apparatus, a method for controlling a mobile apparatus, a display apparatus, and a method for displaying a game image in a display apparatus, and more particularly, to a server which performs N-Screen game by using a manipulation content which is provided from a server and a game image, a method for controlling a game in a server, a mobile apparatus, a method for controlling a mobile apparatus, a display apparatus, and a method for displaying a game image in a display apparatus.

2. Description of the Related Art

With the development of electronic technologies, a method for performing a game by linking a display apparatus with a large screen and a mobile apparatus which is easily manipulable has been developed and popularized.

As an example of the method, there was a method of performing a game between a mobile apparatus and a display apparatus by linking each game application in a mobile apparatus in which a game application corresponding to a platform of the mobile apparatus is installed and a display apparatus in which a game application corresponding to a platform of the display apparatus is installed. However, in this case, it was required to develop a game application per each platform, which caused inconvenience to a game application developer.

In addition, as another example of the method, there was a method of performing a game by displaying a game image which is provided from a server on a display apparatus. However, in this case, a user was able to perform a game only when manipulating the display apparatus by using devices such as a mouse, a keyboard, a remote controller, and a joystick.

### SUMMARY OF THE INVENTION

An aspect of the present invention relates to a manipulation content which is provided from a server, a server which performs a game by using a game image, a method for controlling a game in a server, a mobile apparatus, a method for controlling a mobile apparatus, a display apparatus, and a method for displaying a game image in a display apparatus.

According to an exemplary embodiment for achieving the aforementioned purpose, a method for controlling a game in a server which is connectable to a display apparatus and a mobile apparatus includes, when a game execution command is received from the mobile apparatus, providing the mobile apparatus with a manipulation content which corresponds to the game execution command, generating a game image which corresponds to the game execution command as a real-time stream, and transmitting the generated real-time stream to the display apparatus.

In addition, the method may further include receiving a user control command through a manipulation image which corresponds to the provided manipulation content from the mobile apparatus, and the generating includes generating a game image which corresponds to the received user control command as a real-time stream.

The game execution command may include information on a display apparatus which is synchronized with the mobile apparatus, and the transmitting includes transmitting the generated real-time stream to a display apparatus which corresponds to the information on the display apparatus.

The manipulation content may be a real-time stream of a manipulation image for a user manipulation in game execution.

The game execution command may be a command for executing one game among a plurality of games which are providable from the server, and the manipulation content and the game image may be a manipulation content and a game image which correspond to the executed game.

Meanwhile, according to an exemplary embodiment for achieving the aforementioned purpose, a method for controlling a mobile apparatus which is connectable to a server and a display apparatus includes, when a first application is operated, receiving a manipulation content which corresponds to the first application from the server, displaying a manipulation image which corresponds to the received manipulation content, receiving a user control command from the displayed manipulation image, and transmitting the received user control command to the server so that a game image which corresponds to the user control command is displayed on the display apparatus.

In addition, the method may further include, when the first application is operated, operating a second application of the display apparatus which corresponds to the first application in the display apparatus, receiving apparatus information on the display apparatus from the display apparatus, and transmitting the received apparatus information on the display apparatus to the server.

In addition, the method may further include updating the manipulation image in response to the user control command.

The manipulation content may be a real-time stream of a manipulation image for a user manipulation in game execution.

Meanwhile, according to an exemplary embodiment for achieving the aforementioned purpose, a method for displaying a game image in a display apparatus which is connectable to a server and a mobile apparatus includes, when a synchronization command is received according to operation of the first application which is installed in the mobile apparatus, operating the second application of the display apparatus which corresponds to the first application, when the second application is operated, receiving a game image which corresponds to the first application as a real-time stream from the server, and displaying the received real-time stream.

Meanwhile, according to an exemplary embodiment for achieving the aforementioned purpose, a server includes, a communication unit which communicates with a display apparatus and a mobile apparatus which are connectable to the server and a controller which, when a game execution command is received from the mobile apparatus, generates a manipulation content corresponding to the game execution command, generates a game image corresponding to the game execution command as a real-time stream, and controls the communication unit to transmit the generated manipulation content and real-time stream to the display apparatus.

The communication unit may receive a user control command through a manipulation image which corresponds to the transmitted manipulation content from the mobile apparatus, and the controller may generate a game image which corresponds to the received user control command as a real-time stream.

The game execution command may includes information on a display apparatus which is synchronized with the mobile apparatus, and the controller may control the communication unit to transmit the generated real-time stream to a display apparatus which corresponds to the information on the display apparatus.

The manipulation content may be a real-time stream of a manipulation image for a user manipulation in game execution.

The game execution command may be a command for executing one game among a plurality of games which are providable from the server apparatus, and the manipulation content and the game image may be a manipulation content and a game image which correspond to the executed game.

Meanwhile, according to an exemplary embodiment for achieving the aforementioned purpose, a mobile apparatus which is connectable to a server and a display apparatus includes, a communication unit which, when the first application is operated, receives a manipulation content which corresponds to the first application from the server, a display which displays a manipulation image corresponding to the received manipulation content, an input unit which receives a user control command from the displayed manipulation image, and a controller which controls the communication unit to transmit the received user control command to the server so that a game image which corresponds to user control command is displayed on the display apparatus.

The communication unit, when the first application is operated, may operate the second application of the display apparatus which corresponds to the first application in the display apparatus, and receive apparatus information on the display apparatus from the display apparatus, and the controller may control the communication unit to transmit the received apparatus information on the display apparatus to the server.

The controller may control the display to update and display the manipulation image in response to the user control command.

The manipulation content may be a real-time steam of a manipulation image for a user manipulation in game execution.

Meanwhile, according to an exemplary embodiment for achieving the aforementioned purpose, a display apparatus which is connectable to a server and a mobile apparatus includes, a controller which, when a synchronization command is received according to operation of the first application which is installed in the mobile apparatus, operates the second application of the display apparatus which corresponds to the first application, a communication unit which, when the second application is operated, receives a game image corresponding to the first application as a real-time stream from the server, and a display which displays the received real-time stream.

Another exemplary embodiment is game system for playing a game, the game system interfacing with a display apparatus, a server and a mobile apparatus, the game system comprising a first application on the mobile apparatus, the first application synchronizing with the display apparatus and executing the game. A second application not residing on the mobile apparatus manipulates content related to the game. The server provides a game image based on the manipulated content to the display device on a real-time basis.

In accordance with the aforementioned various exemplary embodiments, as a sever provides a game image to be displayed on a display apparatus and a manipulation image to be displayed on a mobile apparatus, a game application to be installed in a display apparatus platform and a mobile apparatus platform may be developed more easily.

In addition, in accordance with the aforementioned various exemplary embodiments, it is possible to manipulate a game by using a manipulation screen which is displayed on a mobile apparatus, not by using a mouse or a keyboard, etc., and thus various scenarios which are associated with a game execution may be realized.

### BRIEF DESCRIPTION OF THE DRAWINGS

FIG. 1 is a view illustrating a game execution system in accordance with an exemplary embodiment;

FIG. 2 is a block diagram of a server in accordance with an exemplary embodiment;

FIG. 3 is a block diagram of a mobile apparatus in accordance with an exemplary embodiment;

FIG. 4 is a block diagram of a display apparatus in accordance with an exemplary embodiment; and

FIG. 5 is a timing diagram illustrating a method for controlling a game execution in accordance with an exemplary embodiment.

### DESCRIPTION OF THE PREFERRED EMBODIMENT

Certain exemplary embodiments are described in greater detail below with reference to the accompanying drawings.

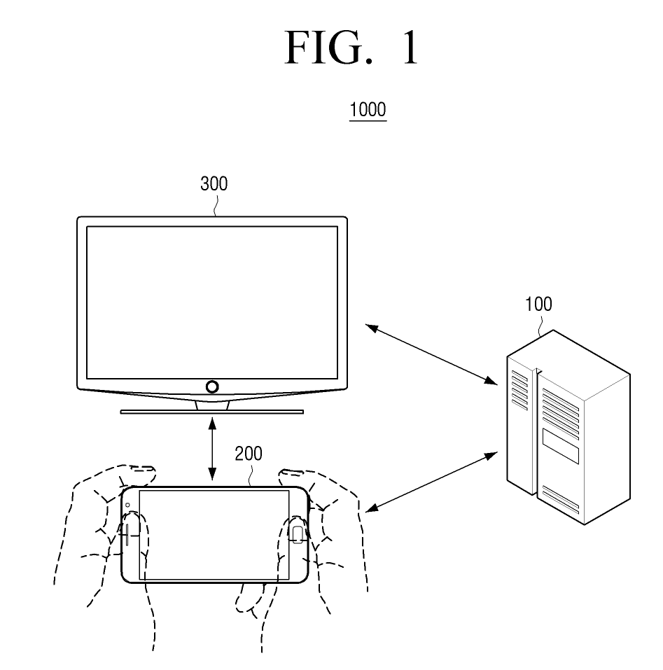

FIG. 1 is a view illustrating a game execution system in accordance with an exemplary embodiment. Referring to FIG. 1, a game execution system 1000 includes a part or all of a server 100, a mobile apparatus 200, and a display apparatus 300. In this case, the server 100 may be realized as a physical server or a cloud server. In addition, the mobile apparatus 200 may be realized as various devices which a user is easily able to carry and manipulate, such as PDA (Personal Digital Assistants) and PMP (Portable Multimedia Player), etc. In addition, the display apparatus 300 may be realized as various devices having a large screen which a user is able to watch in comfort, such as a smart TV, a desktop computer, a laptop computer, a smart phone, a tablet computer, PDA (Personal Digital Assistants) and PMP (Portable Multimedia Player), etc.

When the first application is operated in the mobile apparatus 200, the mobile apparatus 200 may transmit a synchronization command to operate the second application of the display apparatus 300 which corresponds to the operated first application in the display apparatus 300. In this case, the display apparatus 300 may operate the second application, and transmit apparatus information on the display apparatus 300 to the mobile apparatus 200. In this case, the apparatus information of the display apparatus 300 may be a unique identification information on the display apparatus 300.

When the first application is operated in the mobile apparatus 200, the mobile apparatus 200 may access the server 100. In this case, the mobile apparatus 200 may receive and display an operation image which corresponds to the operated first application from the server 100. The operation image may include an area for being assigned a plurality of games which are providable from the server 100.

When one game among the plurality of games is selected in an operation screen which is displayed in the mobile apparatus 200, the mobile apparatus may transmit a game execution command for the selected game to the server 100. The game execution command may include apparatus information on the display apparatus 300.

In this case, the server 100 may execute a game which corresponds to the received game execution command.

In addition, the server 100 may generate a manipulation content which corresponds to the executed game, and transmit the manipulation content to the mobile apparatus 200. In this case, the server 100 may generate and transmit a manipulation content for a user manipulation in game execution in a form of a single file. Or, the server 100 may generate and transmit a real-time stream of a manipulation content for the user manipulation in game execution.

The server 100 mat generate a game image which corresponds to the executed game as a real-time stream, and transmit the generated real-time stream to the display apparatus 300 which corresponds to the received apparatus information on the display apparatus 300.

Accordingly, the mobile apparatus 200 may display a manipulation image for a user manipulation in the executed game. In addition, the display apparatus 300 may display a game image of the executed game.

The mobile apparatus 200 may receive a user control command for manipulating the executed game through the displayed manipulation image. In this case, the mobile apparatus 200 may transmit the received user control command to the server 100.

In this case, the server 100 may generate a game image which corresponds to the received user control command as a real-time stream, and transmit the generated real-time stream to the display apparatus 300. Accordingly, the display apparatus 300 may display a game image which is changed according to the user control command.

The mobile apparatus 200 may update and display a manipulation image in response to a user control command. If the mobile apparatus 200 receives and stores a manipulation content for a user manipulation in the form of a single file, the mobile apparatus 200 may detect and update a manipulation image which corresponds to a user control command. Or, if the mobile apparatus 200 receives a manipulation image for a user manipulation as a real-time stream from the server 100, and the manipulation image which corresponds to a user control command is generated as a real-time stream, the mobile apparatus 200 may receive and update the generated real-time stream.

According to the above descriptions, it was explained that, when the first application is operated in the mobile apparatus 200, the aforementioned steps are performed, but as occasion demands, the aforementioned steps may be performed when the second application is operated in the display apparatus 300.

The aforementioned first application and second application may be applications for executing a game by synchronizing the mobile apparatus 200 and the display apparatus 300 and receiving a game image or a manipulation content from the server 100. That is, the first application and the second application may be different from an application which is made by including all of game execution codes for displaying a game image or a manipulation content.

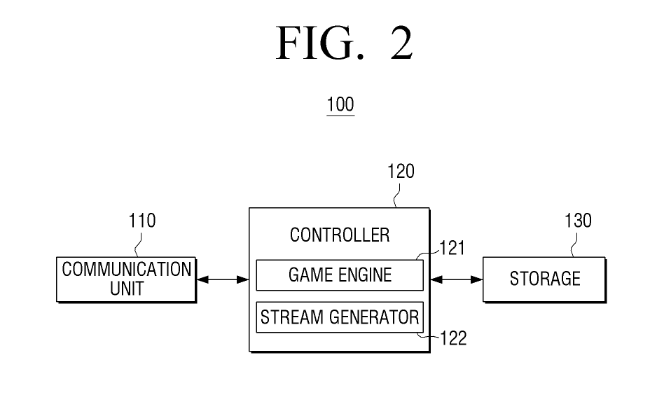

FIG. 2 is a block diagram of a server in accordance with an exemplary embodiment. Referring to FIG. 2, the server 100 includes a part or all of a communication unit 110, a storage 130, and a controller 120. In this case, the controller 120 may include a part or all of a game engine 121 and a stream generator 122.

The communication unit 110 may communicate with an external apparatus which is connectable to the server 100. Particularly, the communication unit 110 communicates with the mobile apparatus 200 and the display apparatus 300 which are connectable to the server 100.

In this case, the communication unit 110 may be configured in a form of being connected in a wireless or wired means through LAN (Local Area Network) and an internet network, being connected through a USB (Universal Serial Bus) port, being connected through a mobile communication network such as 3G and 4G, or being connected through a short-range wireless communication means such as NFC (Near Field Communication) and RFID (Radio Frequency Identification).

The storage 130 stores data and an application which are necessary for operation of the server 100. Particularly, the storage 130 may store a plurality of game applications which are providable from the server 100.

The storage 130 may be realized as a storage element in a detachable form such as a USB memory and a CD-ROM as well as a storage element in a embedded form such as RAM (Random Access Memory), a flash memory, ROM (Read Only Memory), EPROM (Erasable Programmable ROM), EEPROM (Electronically Erasable and Programmable ROM), a register, a hard disk, a removable disk, and a memory card, etc.

The controller 120 controls overall operations of the server 100. Particularly, when the first application is operated in the mobile apparatus 200 and connected to the server 100, the controller 120 may generate an operation image which corresponds to the operated first application. In this case, the controller 120 may control the communication unit 110 to transmit the generated operation image to the mobile apparatus 200. The operation image may be an initial image which is initially displayed when the first application is operated in the mobile apparatus 200, and may include an area for being assigned a plurality of games which are providable from the server 100.

When one game among a plurality of games is selected in an operation image which is displayed in the mobile apparatus 200, and a game execution command of the selected game is received from the mobile apparatus 200 through the communication unit 110, the controller 130 may execute the selected game. To be specific, the game engine 131 may execute the selected game by detecting and executing a game application which corresponds to the received game execution command among a plurality of game applications which are stored in the storage 130. The game execution command may include apparatus information of the display apparatus 300.

When a game is executed, the controller 120 may generate a manipulation content which corresponds to the executed game. To be specific, the game engine 121 may generate a manipulation content for a user manipulation in performing the executed game in the form of a single file. In this case, the manipulation content may include all of manipulation images for the user manipulation in performing the executed game.

Or, the game engine 121 may transmit information on the manipulation image for the user manipulation in performing the executed game to the stream generator 122, and in this case, the stream generator 122 may generate a manipulation content as a real-time stream of the manipulation image by using information on the manipulation image.

Meanwhile, the controller 120 may control the communication unit 110 to transmit the generated manipulation content to the mobile apparatus 200.

The manipulation content may refer to a content for manipulating a game which is executed according to a game image which is displayed in the display apparatus 300. For example, a manipulation content may include a manipulation image which includes a plurality of direction keys for controlling a movement direction of a character which is displayed in a game image. Or, in case of poker game, a manipulation content may include a manipulation image of a private view in the poker game which is displayed in the display apparatus 300.

When a game is executed, the controller 120 may generate a game image which corresponds to the executed game. To be specific, the game engine 121 may transmit information on a game image which corresponds to the executed game to the stream generator 122, and in this case, the stream generator 122 may generate the game image as a real-time stream by using information on the game image.

The controller 120 may control the communication unit 110 to transmit the generated game image to the display apparatus 300. In this case, the display apparatus 300 to receive the game image may be detected by using apparatus information on a display apparatus which is included in a game execution command.

Meanwhile, a user control command for manipulating the executed game is received from the mobile apparatus 200 through the communication unit 110, the controller 120 may generate a game image which corresponds to the received user control command as a real-time stream. In this case, the controller 120 may control the communication unit 110 to transmit the generated real-time stream to the display apparatus 300.

The controller 120 may generate a manipulation image which corresponds to a user control command as a real-time stream. In this case, the controller 120 may control the communication unit 110 to transmit the generated real-time stream to the mobile apparatus 200.

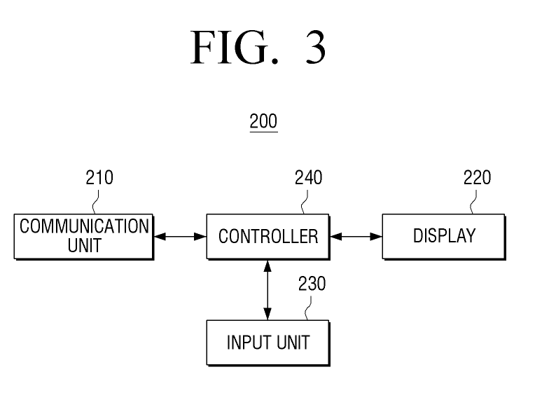

FIG. 3 is a block diagram of a mobile apparatus in accordance with an exemplary embodiment. Referring to FIG. 3, the mobile apparatus 200 includes a part or all of a communication unit 210, a display 220, an input unit 230, and a controller 240.

The communication unit 210 may communicate with an external apparatus which is connectable to the mobile apparatus 200. Particularly, the communication unit 210 communicates with the server 100 and the display apparatus 300 which are connectable to the mobile apparatus 200.

In this case, the communication unit 210 may be configured in a form of being connected in a wireless or wired means through LAN (Local Area Network) and an internet network, being connected through a USB (Universal Serial Bus) port, being connected through a mobile communication network such as 3G and 4G, or being connected through a short-range wireless communication means such as NFC (Near Field Communication) and RFID (Radio Frequency Identification).

The display 220 displays a screen. Particularly, the display 220 may display an operation image according to operation of the first application and a manipulation image for a user manipulation in game execution.

The display 220 may be realized as at least one among a liquid crystal display, a thin film transistor-liquid crystal display, an organic light-emitting diode, a flexible display, a 3D display, and a transparent display.

The input unit 230 receives a user control command regarding the mobile apparatus 200. Particularly, the input unit 230 receives a user control command for being assigned the first application and a user control command regarding a manipulation image which is displayed in the display 220.

The input unit 230 may be realized by using at least one among various forms of buttons, a touch sensor which receives a touch input regarding the display 220, a proximity sensor which receives a motion which accesses the display 220 without being directly connected to the surface of the display 220, and a microphone which receives a voice input of a user. In addition, the input unit 230 may be realized by combining an input apparatus such as a mouse, a keyboard, and a remote controller, etc. with a display apparatus such as the display 220. Accordingly, the input unit 230 may receive various user inputs such as a touch input, a motion input, and a voice input, etc.

The controller 240 controls overall operations of the mobile apparatus 200. To be specific, the controller 240 may control a part or all of the communication unit 210, the display 220, and the input unit.

Particularly, when the first application is operated, the controller 240 may control the communication unit 210 to transmit a synchronization command to operate the second application of the display apparatus 300 which corresponds to the operated first application in the display apparatus 300. In this case, the communication unit 210 may receive apparatus information on the display apparatus 300 from the display apparatus 300.

When the first application is operated, the controller 240 may control the communication unit 210 to connect to the server 100.

In addition, when an operation image is received through the communication unit 210 as the communication unit 210 is connected to the server 100, the controller 240 may control the display 220 to display the received operation image.

When a game among a plurality of games is selected in an operation image which is displayed in the display 220, the controller 240 may control the communication unit 210 to transmit a game execution command of the selected game. In the case, the game execution command may include apparatus information on the display apparatus 300.

When a manipulation content is received from the server 110 as the game is executed, the controller 240 may control the display 220 to display a manipulation image which corresponds to the received manipulation content.

When a user control command for controlling a game which is displayed in the display apparatus 300 is received from the manipulation image which is displayed in the display 220, the controller 240 may control the communication unit 210 to transmit the received user control command to the server 100.

The controller 240 may update and display the manipulation image in response to the received user control command. That is, when the mobile apparatus 200 receives and stores a manipulation content for a user manipulation in the form of a single file, the controller 240 may control the display 220 to detect a manipulation image which corresponds to a user control command from the stored manipulation content and display the manipulation content. Or, when the mobile apparatus 200 receives a manipulation image for a user manipulation from the server 100 as a real-time stream, the controller 240 may control the display 220 to display a manipulation image of the received real-time stream.

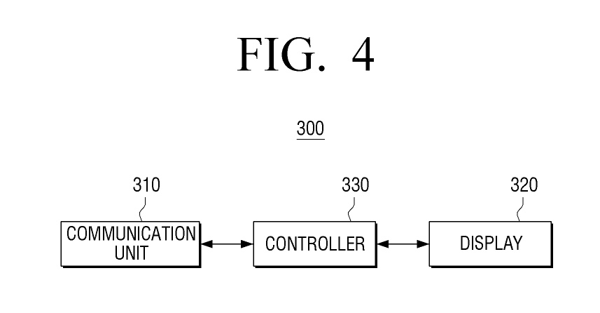

FIG. 4 is a block diagram of a display apparatus in accordance with an exemplary embodiment. Referring to FIG. 4, the display apparatus 300 includes a part or all of a communication unit 310, a display 320, and a controller 330.

The communication unit 310 may communicate with an external apparatus which is connectable to the display apparatus 300. Particularly, the communication unit 310 communicates with the server 100 and the mobile apparatus 200 which are connectable to the display apparatus 300.

The communication unit 310 may be configured in a form of being connected in a wireless or wired means through LAN (Local Area Network) and an internet network, being connected through a USB (Universal Serial Bus) port, being connected through a mobile communication network such as 3G and 4G, or being connected through a short-range wireless communication means such as NFC (Near Field Communication) and RFID (Radio Frequency Identification).

The display 320 displays a screen. Particularly, the display 320 may display a game image.

The display 320 may be realized as at least one among a liquid crystal display, a thin film transistor-liquid crystal display, an organic light-emitting diode, a flexible display, a 3D display, and a transparent display.

The controller 330 controls overall operations of the display apparatus 300. To be specific, the controller 330 may control a part or all of the displays 320.

Particularly, when a synchronization command is received through the communication unit 310 as the first application which is installed in the mobile apparatus 200 is operated, the controller 330 may operate the second application of a display apparatus which corresponds to the first application. In this case, the controller 330 may control the communication unit 310 to transmit apparatus information of the display apparatus 300 to the mobile apparatus 200 which transmitted the synchronization command.

In addition, when the second application is operated and a game image which corresponds to a game which is executed in the server 100 is received as a real-time stream, the controller 330 may control the display 320 to display a game image of the received real-time stream.

In addition, according to a user control command in a manipulation image which is displayed in the mobile apparatus 200, when the server 100 generates and transmits a game image which corresponds to the user control command as a real-time stream, the controller 330 may control the display 320 to display a game image of a real-time stream which corresponds to the user control command which is received from the server 100.

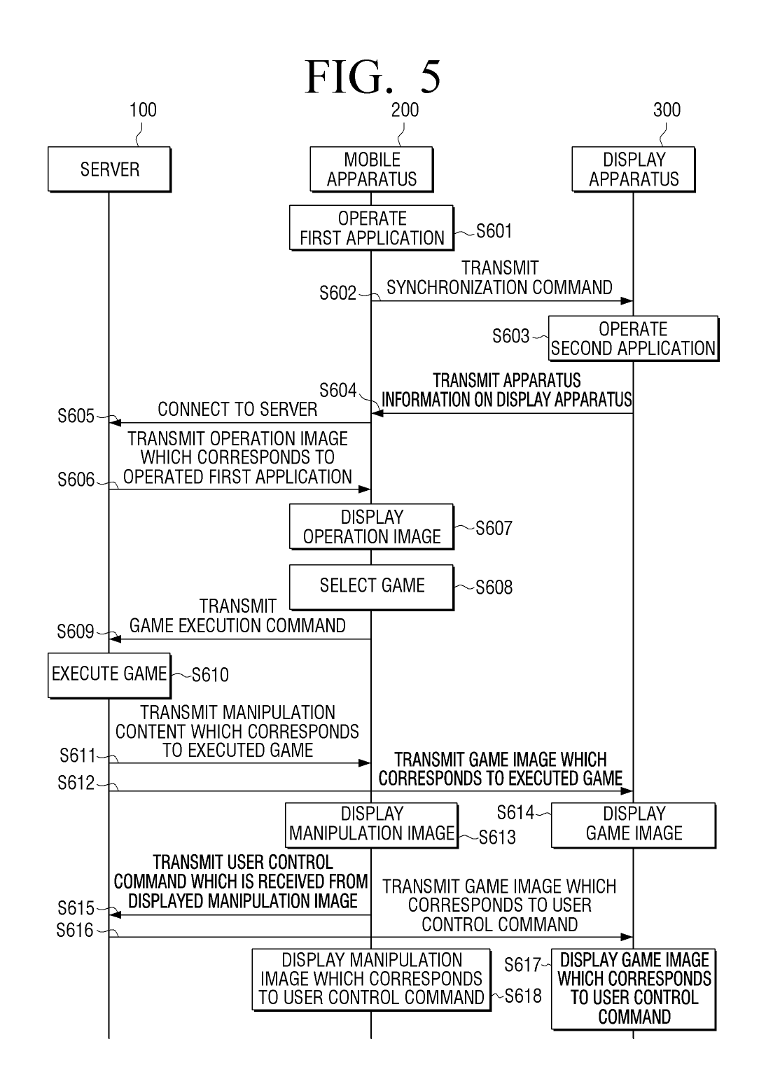

FIG. 5 is a timing diagram illustrating a method for controlling a game execution in accordance with an exemplary embodiment. Referring to FIG. 5, the mobile apparatus 200 may operate the first application (S601). In addition, the mobile apparatus 200 may transmit a synchronization command to operate the second application of the display apparatus 300 which corresponds to the operated first application in the display apparatus 300 (S602). In this case, the display apparatus 300 may operate the second application (S603). In addition, the display apparatus 300 may transmit apparatus information on the display apparatus 300 to the mobile apparatus 200 (S504).

When the first application is operated in the mobile apparatus 200, the mobile apparatus 200 may connect to the server 100 (S605). In this case, the server 100 may transmit an operation image which corresponds to the operated first application to the mobile apparatus 200 (S606). In addition, the mobile apparatus 200 may display the received operation image (S607). In this case, the operation image may include an area for being assigned a plurality of games which are providable from the server 100.

When a game among the plurality of games is selected in an operation screen which is displayed in the mobile apparatus 200 (S508), the mobile apparatus 200 may transmit a game execution command of the selected game to the server 100 (S609). The game execution command may include apparatus information on the display apparatus 300.

In this case, the server 100 may execute a game which corresponds to the received game execution command (S610).

In addition, the server 100 may generate a manipulation content which corresponds to the executed game, and transmit the manipulation content to the mobile apparatus 200 (S611). In this case, the server 100 may generate and transmit a manipulation content for a user manipulation in game execution in the form of a single file. Or, the server 100 may generate and transmit a real-time stream of a manipulation content for a user manipulation in game execution.

The server 100 may generate a game image which corresponds to the executed game as a real-time stream, and transmit the generated real-time stream to the display apparatus 300 which corresponds to the received apparatus information on the display apparatus 300 (S612).

Accordingly, the mobile apparatus 200 may display a manipulation image for a user manipulation in the executed game (S613). In addition, the display apparatus 300 may display a game image regarding the executed game (S614).

Meanwhile, the mobile apparatus 200 may receive a user control command for controlling the executed game through the displayed manipulation image. In this case, the mobile apparatus 200 may transmit the received user control command to the server 100 (S615).

In this case, the server 100 may generate a game image which corresponds to the received user control command as a real-time stream, and transmit the generated real-time stream to the display apparatus 300 (S616). The display apparatus 300 may display a game image which is changed according to the user control command (S617).

In addition, the mobile apparatus 200 may update and display a manipulation image in response to the user control command (S618). When the mobile apparatus 200 receives and stores a manipulation content for a user manipulation in the form of a single file, the mobile apparatus 200 may detect and update a manipulation image which corresponds to the user control command. Or, when the mobile apparatus 200 receives a manipulation image for a user manipulation from the server 100 as a real-time stream, and a manipulation image which corresponds to the user control command is generated as a real-time stream, the mobile apparatus 200 may receive and update the generated real-time stream.

In accordance with the aforementioned various exemplary embodiments, as a sever provides a game image to be displayed on a display apparatus and a manipulation image to be displayed on a mobile apparatus, a game application to be installed in a display apparatus platform and a mobile apparatus platform may be developed more easily. That is, as the sever provides the game image to be displayed in the display apparatus and the manipulation image to be displayed in the mobile apparatus, there is no need to install an application including all game execution codes for executing a game in a display apparatus platform, and an application including all game execution codes for executing a game in a mobile apparatus platform, and thus it is possible to develop an application to be installed in each platform more easily.

In addition, in accordance with the aforementioned various exemplary embodiments, it is possible to manipulate a game by using a manipulation screen which is displayed on a mobile apparatus, not by using a mouse or a keyboard, etc., and thus various scenarios which are associated with a game execution may be realized.

Various methods in accordance with the aforementioned various exemplary embodiments may be realized as a program code, and provided to each apparatus by being stored in various non-transitory computer readable medium.

A non-transitory computer readable medium refers to a medium which stores data semi-permanently and is readable by a device, not a medium which stores data for a brief time such as a register, a cache, and a memory. To be specific, the aforementioned various applications or programs may be provided by being stored in a non-transitory computer readable medium such as a CD, a DVD, a hard disk, a BlueRay disk, a USB, a memory card, and a ROM, etc.

As given above, desirable exemplary embodiments have been shown and described, but the present invention is not limited to the aforementioned particular exemplary embodiments, could be variously modified and achieved by those skilled in the art to which the present invention pertains without deviating from the substance of the present invention which is claimed in the claims, and such modification should not be understood separately from the technical concept or prospect of the present invention.

What is claimed is:

1. A method for controlling a game using a server, the server being connectable to a display apparatus and a mobile apparatus, the method comprising:
when a game execution command is received from the mobile apparatus, providing the mobile apparatus with a manipulation content, the manipulation content corresponding to the game execution command;
generating a game image as a real-time stream, the game image corresponding to the game execution command; and
transmitting the generated real-time stream to the display apparatus.

2. The method as claimed in claim 1, further comprising:
receiving a user control command through a manipulation image, the manipulation image corresponding to the provided manipulation content; and
wherein the generating comprises generating a game image as a real-time stream, the game image corresponding to the received user command.

3. The method as claimed in claim 1, wherein the game execution command comprises information on a display apparatus, the display apparatus being synchronized with the mobile apparatus, and
wherein the transmitting comprises transmitting the generated real-time stream to a display apparatus, the real-time stream corresponding to the information on the display apparatus.

4. The method as claimed in claim 1, wherein the manipulation content is a real-time stream of a manipulation image for a user manipulation in game execution.

5. The method as claimed in claim 1, wherein the game execution command is a command for executing one game among a plurality of games, the plurality of games being providable from the server, and
wherein the manipulation content and the game image correspond to the executed game.

6. A method for controlling a mobile apparatus, the mobile apparatus being connectable to a server and a display apparatus, the method comprising:
when a first application is operated, receiving a manipulation content corresponding to the first application from the server;
displaying a manipulation image corresponding to the received manipulation content;
receiving a user control command from the displayed manipulation image; and
transmitting the received user control command to the server so that a game image corresponding to the user control command is displayed on the display apparatus.

7. The method as claimed in claim 6, further comprising:
when the first application is operated, operating a second application of the display apparatus in the display apparatus, the second application corresponding to the first application,
receiving apparatus information on the display apparatus from the display apparatus; and
transmitting the received apparatus information on the display apparatus to the server.

8. The method as claimed in claim 6, further comprising:
updating the manipulation image in response to the user control command.

9. The method as claimed in claim 6, wherein the manipulation content is a real-time stream of a manipulation image for a user manipulation in game execution.

10. A method for displaying a game image in a display apparatus, the display apparatus being connectable to a server and a mobile apparatus, the method comprising:
when a synchronization command is received according to operation of a first application installed in the mobile apparatus, operating a second application of the display apparatus, the second application corresponding to the first application;
when the second application is operated, receiving a game image as a real-time stream from the server, the game image corresponding to the first application; and
displaying the received real-time stream.

11. A server, comprising:
a communication unit which communicates with a display apparatus and a mobile apparatus, the display apparatus and the mobile apparatus being connectable to the server; and
a controller which, when a game execution command is received from the mobile apparatus, generates a manipulation content corresponding to the game execution command, generates a game image corresponding to the game execution command as a real-time stream, and controls the communication unit to transmit the generated manipulation content and real-time stream to the display apparatus.

12. The server as claimed in claim 11, wherein the communication unit receives a user control command through a manipulation image, the manipulation image corresponding to the transmitted manipulation content from the mobile apparatus, and
wherein the controller generates a game image as a real-time stream, the game image corresponding to the received user control command.

13. The server as claimed in claim 11, wherein the game execution command comprises information on a display apparatus, the display apparatus being synchronized with the mobile apparatus, and
wherein the controller controls the communication unit to transmit the generated real-time stream to a display apparatus, the real-time stream corresponding to information on the display apparatus.

14. The server as claimed in claim 11, wherein the manipulation content is a real-time stream of a manipulation image for a user manipulation in game execution.

15. The server as claimed in claim 11, wherein the game execution command is a command for executing one game among a plurality of games, the plurality of games being providable from the server, and
wherein the manipulation content and the game image correspond to the executed game.

16. A mobile apparatus which is connectable to a server and a display apparatus, comprising:
a communication unit which, when a first application is operated, receives a manipulation content, the manipulation content corresponding to the first application from the server;
a display apparatus which displays a manipulation image corresponding to the received manipulation content;
an input unit which receives a user control command from the displayed manipulation image; and
a controller which controls the communication unit to transmit the received user control command to the server so that a game image which corresponds to user control command is displayed on the display apparatus.

17. The mobile apparatus as claimed in claim 16, wherein the communication unit, when the first application is operated, operates the second application of the display apparatus which corresponds to the first application in the display apparatus, and receives apparatus information on the display apparatus from the display apparatus, and
wherein the controller controls the communication unit to transmit the received apparatus information on the display apparatus to the server.

18. The mobile apparatus as claimed in claim 16, wherein the controller controls the display to update and display the manipulation image in response to the user control command.

19. The mobile apparatus as claimed in claim 16, wherein the manipulation content is a real-time steam of a manipulation image for a user manipulation in game execution.

20. A display apparatus which is connectable to a server and a mobile apparatus, comprising:
a controller which, when a synchronization command is received according to operation of a first application which is installed in the mobile apparatus, operates a second application of the display apparatus which corresponds to the first application;
a communication unit which, when the second application is operated, receives a game image corresponding to the first application as a real-time stream from the server; and
a display which displays the received real-time stream.
